(19) United States
(12) Patent Application Publication
(10) Pub. No.: US 2026/0323446 A1
(43) Pub. Date: Oct. 15, 2026

(54) COMMUNICATION METHOD, NETWORK NODE AND USER EQUIPMENT

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/693,211

(22) Filed: May 29, 2026

Related U.S. Application Data
(63) Continuation of application No. PCT/JP2024/041896, filed on Nov. 27, 2024.

(30) Foreign Application Priority Data
Nov. 30, 2023 (JP) 2023-203218

(51) Int. Cl. H04W 36/08; H04W 56/00; H04W 76/20

(52) U.S. Cl. CPC H04W 36/08; H04W 56/0015; H04W 76/20

(57) ABSTRACT

A communication method for performing cell switching to switch a serving cell of a user equipment from a first cell to a second cell includes configuring, by a first network node configured to manage a first cell, a user equipment with, as a condition to execute an operation related to the cell switching, a first condition to execute uplink early synchronization with the second cell and/or a second condition to execute the cell switching, and receiving, by the first network node, a notification indicating the execution of the operation from the user equipment or a second network node configured to manage the second cell, based on the condition being satisfied at the user equipment.

### RELATED APPLICATIONS

The present application is a continuation based on PCT Application No. PCT/JP2024/041896, filed on Nov. 27, 2024, which claims the benefit of Japanese Patent Application No. 2023-203218 filed on Nov. 30, 2023. The content of which is incorporated by reference herein in their entirety.

### TECHNICAL FIELD

The present disclosure relates to a communication method, a network node, and a user equipment used in a mobile communication system.

### BACKGROUND

The 3rd Generation Partnership Project (3GPP) (trade name, the same applies to the following descriptions) has defined the technical specifications of New Radio (NR) that is a radio access technology of the fifth generation (5G). In 3GPP mobile communication systems, a serving cell switching (serving cell change) of a user equipment in a radio resource control (RRC) connected state is indicated by transmitting a message (so-called handover command) of an RRC layer corresponding to a layer 3 (L3) from a network node to the user equipment.

On the other hand, in Release 18 of the 3GPP standard (3GPP Release 18), technical specifications of L1/L2 Triggered Mobility (LTM) that is a new procedure for the serving cell switching are being formulated. The LTM is a procedure in which a network node receives a layer 1 (L1) measurement report from a user equipment, and based on this, the network node changes a serving cell for the user equipment by means of a cell switch command that the network node signals to the user equipment by a Media Access Control (MAC) Control Element (CE).

### CITATION LIST

### Non-Patent Literature

Non-Patent DOCUMENT 1: 3GPP Contribution R2-2309335

### SUMMARY

The present disclosure provides a communication method, a network node, and a user equipment for efficiently implementing conditional LTM (C-LTM) and/or RACH-less conditional handover (RL-CHO).

A communication method according to a first aspect is a communication method for performing cell switching to switch a serving cell of a user equipment from a first cell to a second cell, the communication method including: configuring, by a first network node configured to manage a first cell, a user equipment with, as a condition to execute an operation related to the cell switching, a first condition to execute uplink early synchronization with the second cell and/or a second condition to execute the cell switching; and receiving, by the first network node, a notification indicating the execution of the operation from the user equipment or a second network node configured to manage the second cell, based on the condition being satisfied at the user equipment.

A network node according to a second aspect is a network node for managing a first cell in a mobile communication system for performing cell switching to switch a serving cell of a user equipment from the first cell to a second cell, the network node including: a controller configured to configure a user equipment with, as a condition to execute an operation related to the cell switching, a first condition to execute uplink early synchronization with the second cell and/or a second condition to execute the cell switching; and a receiver configured to receive a notification indicating the execution of the operation from the user equipment or a second network node configured to manage the second cell, based on the condition being satisfied at the user equipment.

A user equipment according to a third aspect is a user equipment in a mobile communication system for performing cell switching to switch a serving cell of the user equipment from a first cell to a second cell, the user equipment including: a receiver configured to receive, from a first network node configured to manage the first cell, information for configuring, as a condition to execute an operation related to the cell switching, a first condition to execute uplink early synchronization with a second cell and/or a second condition to execute the cell switching; and a transmitter configured to transmit a notification indicating the execution of the operation to the first network node, based on the condition being satisfied.

A network node according to a fourth aspect is a network node for managing a second cell in a mobile communication system for performing cell switching to switch a serving cell of a user equipment from a first cell to the second cell, the network node including: a receiver configured to receive, from a user equipment configured with a condition to execute uplink early synchronization with the second cell, a random access signal for uplink early synchronization in response to the condition being satisfied at the user equipment; and a transmitter configured to transmit a notification indicating the execution of the uplink early synchronization to a first network node, based on the receiving of the random access signal.

### BRIEF DESCRIPTION OF THE DRAWINGS

FIG. 1 is a diagram illustrating a configuration example of a mobile communication system according to an embodiment.

FIG. 2 is a diagram illustrating a configuration example of a UE (user equipment) according to the embodiment.

FIG. 3 is a diagram illustrating a configuration example of a gNB (network node) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for describing an operation scenario for the mobile communication system according to the embodiment.

FIG. 7 is a diagram illustrating an example of a procedure for LTM of which specifications are being formulated in the 3GPP Release 18.

FIG. 8 is a flowchart illustrating an overview of an operation of the UE for C-LTM/RL-CHO according to the embodiment.

FIG. 9 is a diagram illustrating a specific example of the operation for the C-LTM/RL-CHO of the mobile communication system according to the embodiment.

FIG. 10 is a diagram for describing another operation scenario for the mobile communication system according to the embodiment.

FIG. 11 is a flowchart illustrating an operation of a gNB for improvement of the C-LTM/RL-CHO according to the embodiment.

FIG. 12 is a diagram illustrating an example of a first operation pattern according to the embodiment.

FIG. 13 is a diagram illustrating an example of a second operation pattern according to the embodiment.

### DESCRIPTION OF EMBODIMENTS

According to an embodiment, a mobile communication system is described with reference to the drawings. In the description of the drawings, the same or similar parts are denoted by the same or similar reference signs.

### (1) Configuration of Mobile Communication System

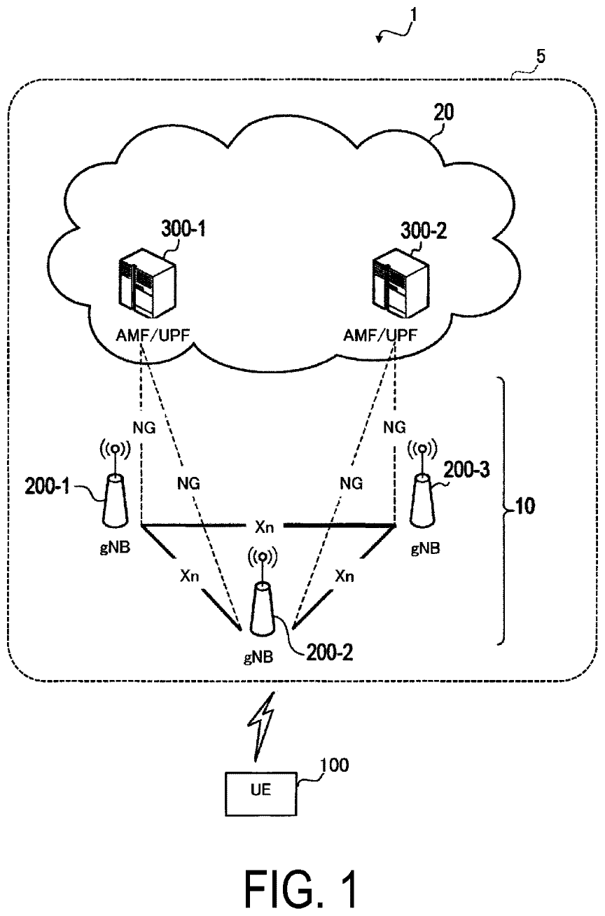

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations 200 (referred to as “gNBs” in 5G systems), which are a type of network node. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

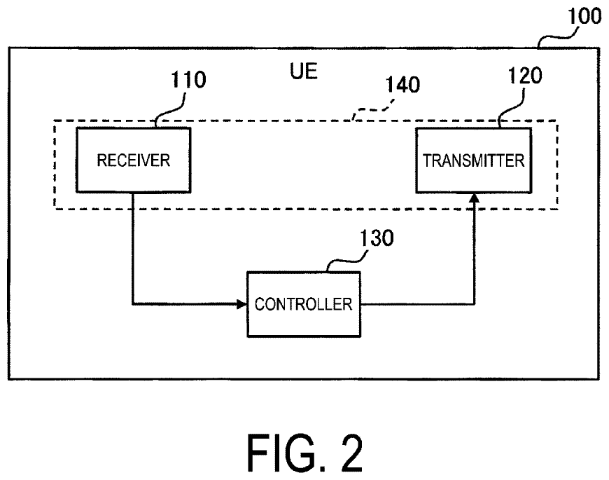

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator 140 that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processing operations in the UE 100. Such processing includes processing of respective layers to be described below. The operations of the UE 100 described above and below may be operations under the control of a controller 230. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

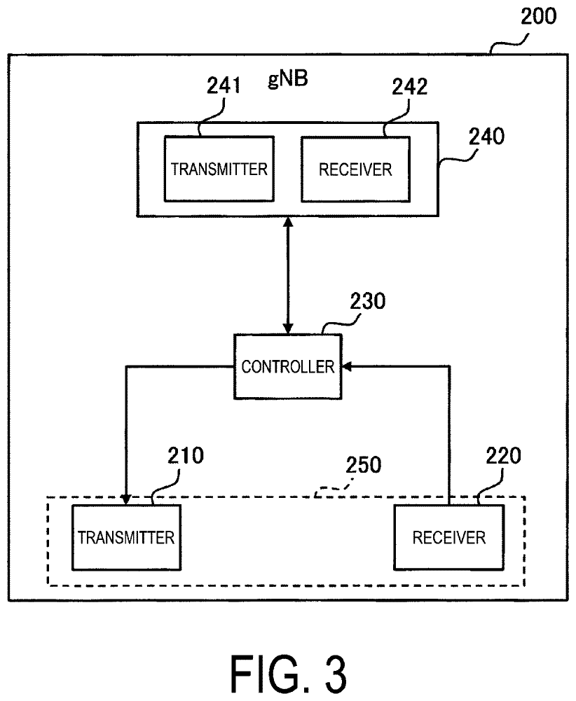

FIG. 3 is a diagram illustrating a configuration example of the gNB 200 (network node) according to the embodiment. The gNB 200 includes a transmitter 210, a receiver 220, a controller 230, and a network communicator 240. The transmitter 210 and the receiver 220 constitute a wireless communicator 250 that performs wireless communication with the UE 100. The network communicator 240 includes a transmitter 241 that performs transmission and a receiver 242 that performs reception.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described below. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The network communicator 240 is connected to a neighboring base station via an Xn interface which is an inter-base station interface. The network communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

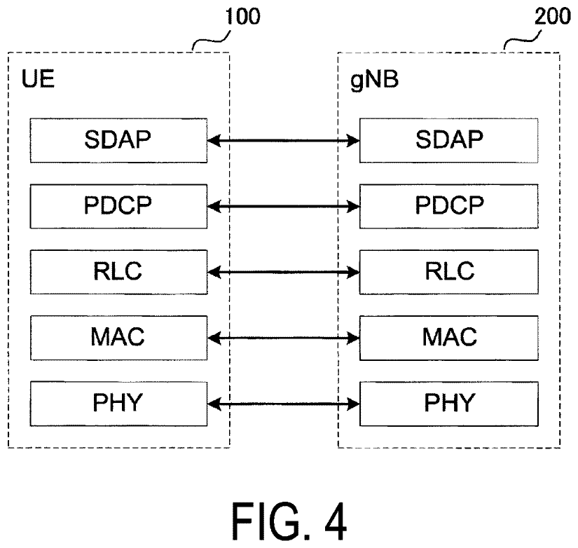

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. CRC parity bits scrambled by the RNTI are added to the DCI transmitted from the gNB 200.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

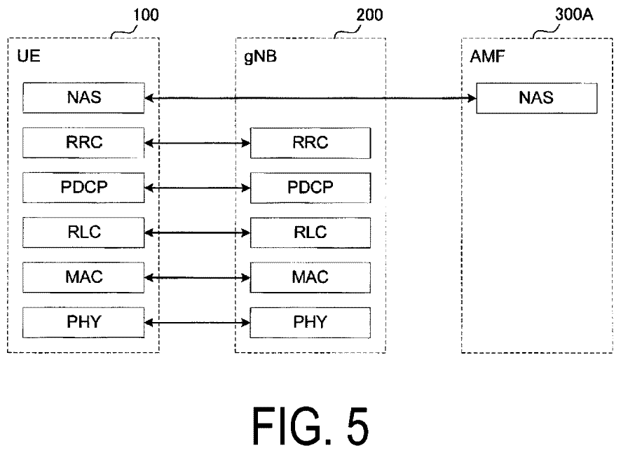

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. The layer below the NAS layer is referred to as an AS layer (also simply referred to as “AS”).

### (2) Overview of LTM

The L1/L2 triggered mobility (LTM) is a technology for reducing a delay in mobility (to be more specific, a delay in a serving cell switching) compared to a general procedure for handover by triggering serving cell switching (cell switching) by signaling of a layer 1 (L1) and/or a layer 2 (L2), which are lower layers.

In the general procedure for handover, a Measurement Report message, which is an RRC message, is transmitted from the UE 100 to the gNB 200, and the gNB 200 determines a handover of the UE 100 based on the Measurement Report message and transmits a handover command, which is an RRC message (to be more specific, an RRC reconfiguration message) from the gNB 200 to the UE 100, thereby a handover is indicated.

An application procedure for general handover includes also a procedure called a conditional handover (CHO). In the conditional handover, a Measurement Report message which is an RRC message is transmitted from the UE 100 to the gNB 200, and the gNB 200 determines a handover candidate cell (CHO candidate cell) for the UE 100 based on the Measurement Report message and the gNB 200 configures a handover execution condition (CHO trigger condition) for the UE 100 in an RRC reconfiguration message which is an RRC message. The UE 100 evaluates whether the handover execution condition is satisfied, and accesses a target cell in response to the handover execution condition being satisfied (that is, the UE 100 autonomously triggers the handover).

In contrast, in the LTM, first, the gNB 200 prepares an LTM candidate cell configuration for a candidate for a switching destination cell, and provides the LTM candidate cell configuration to the UE 100 through RRC signaling. Second, the UE 100 performs processing of synchronization with the candidate cell through an early synchronization (Early sync). Third, the gNB 200 receives an L1 measurement report from the UE 100, determines the cell switching to the target cell based on the L1 measurement report, and transmits a cell switch command indicating the target cell (LTM candidate cell configuration) to the UE 100 by the MAC CE. A cell switching trigger is carried by the MAC CE including at least a candidate configuration index together with a beam indicator. Fourth, the UE 100 changes the serving cell in response to the cell switch command from the gNB 200 (source cell). In this way, the cell switching is triggered by the gNB 200 selecting the LTM candidate cell configuration as a target configuration. The LTM candidate cell configuration can be added, changed and released by the gNB 200 through RRC signaling.

The following principles apply to the LTM.
Each LTM candidate cell configuration can be provided as a difference configuration (delta configuration) relative to a reference configuration used to form the complete candidate cell configuration.
When the complete candidate cell configuration is applied, a current UE configuration is replaced upon the cell switching. A reconfiguration procedure involves a replacement, but not necessarily a reset of the MAC, RLC or PDCP layer.
The user plane, if configured through RRC signaling in order to avoid additional delay of data recovery, is continued without reset.
In the LTM, security is not updated.
The LTM between subsequent LTM candidate cell configurations can be performed without RRC reconfiguration. That is, the UE 100 does not release other LTM candidate cell configurations after the LTM is triggered.

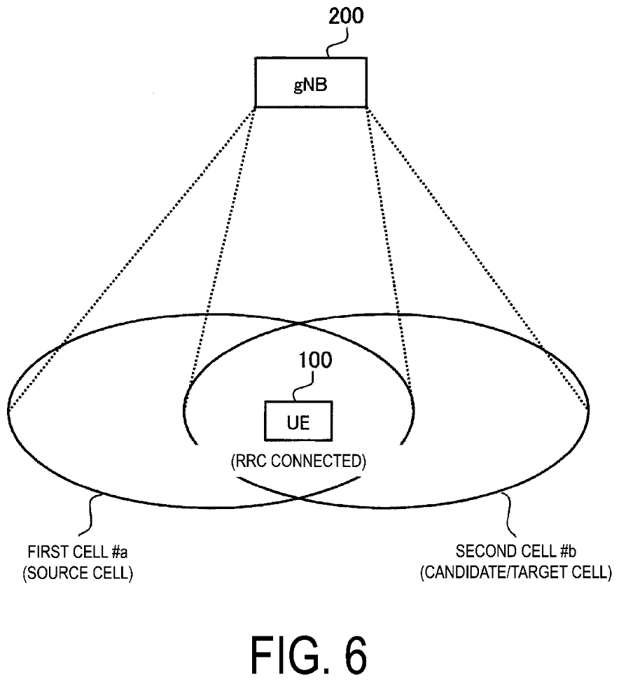

FIG. 6 is a diagram for describing an operation scenario for the mobile communication system 1 according to the embodiment. The UE 100 executes the serving cell switching (cell switching) from a first cell # a (source cell, current serving cell) of the gNB 200 to a second cell # b of the same gNB 200. Note that the cell switching may be synonymous with handover. The first cell # a and the second cell # b may include different transmission and reception points (TRPs). Before the cell switching by the LTM is determined, the second cell # b is also referred to as the “candidate cell (or LTM candidate cell)”, and from when the cell switching by the LTM is determined, the second cell # b is also referred to as the “target cell”.

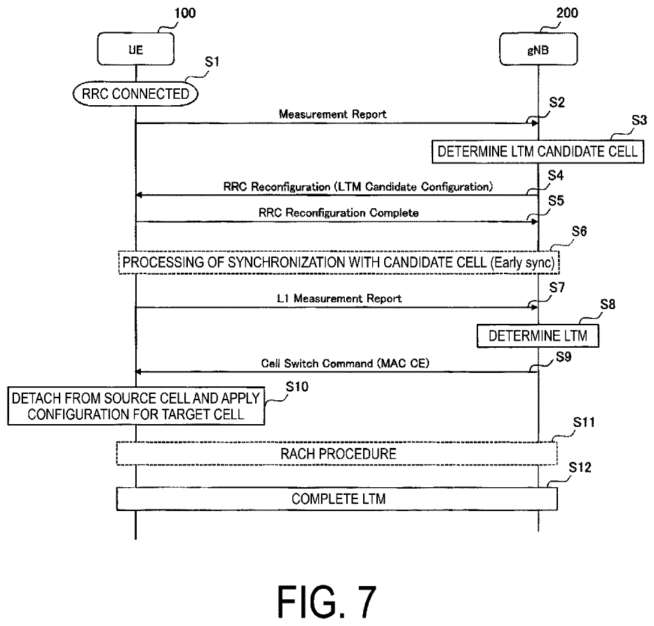

FIG. 7 is a diagram illustrating an example of a procedure for LTM of which specifications are being formulated in the 3GPP Release 18.

In step S1, the UE 100 is in the RRC connected state in a cell (first cell) of the gNB 200.

In step S2, the UE 100 transmits a Measurement Report message, which is an RRC message, to the gNB 200.

In step S3, the gNB 200 determines to use the LTM based on the Measurement Report message and starts preparing the candidate cell.

In step S4, the gNB 200 transmits an RRC Reconfiguration message including the LTM candidate cell configuration (LTM candidate configuration) for one or more candidate cells to the UE 100.

In step S5, the UE 100 saves the LTM candidate cell configuration and transmits an RRC Reconfiguration Complete message to the gNB 200.

In the step S6, the UE 100 may perform the processing of synchronization with the candidate cell before receiving a cell switch command. Such synchronization processing is referred to as early synchronization (Early sync). Here, the UE 100 may perform early timing advance (TA) acquisition with the candidate cell requested by the gNB 200 (source cell) before receiving the cell switch command in step S9. This is done by a contention free random access (CFRA) triggered by a PDCCH order from the source cell. Note that, when DCI Format 1_0 is used and all the “Frequency domain resource assignment” fields in the DCI are set to “1”, the DCI is treated as a PDCCH order. The UE 100 transmits a random access preamble (RA preamble) to the specified candidate cell. In order to minimize the communication interruption of the source cell due to the CFRA to the candidate cell, in the early sync, the UE 100 does not receive a random access response (RAR) for the purpose of acquiring a TA value from the candidate cell. The TA value of the candidate cell (target cell) is indicated in the cell switch command in the step S9. Note that the TA value is a value for adjusting the uplink transmission timing of the UE 100. The TA value may be an offset value indicating a difference between a downlink frame start timing and an uplink frame start timing.

In step S7, the UE 100 performs layer 1 (L1) measurement on the configured candidate cell and transmits a physical layer measurement report (L1 Measurement Report) to the gNB 200. The L1 Measurement Report is transmitted and received on the L1, which is the PHY layer. For example, the UE 100 transmits the L1-RSRP and/or the L1-SINR to the gNB 200 on a physical uplink control channel (PUCCH) and/or a physical uplink shared channel (PUSCH).

In step S8, the gNB 200 determines to perform the cell switching to the target cell (second cell).

In step S9, the gNB 200 transmits a Cell Switch Command (MAC CE) including the candidate configuration index of the target cell to the UE 100. The Cell Switch Command may include a TA value requested in the early sync.

In step S10, the UE 100 switches to the configuration for the target cell. To be specific, the UE 100 detaches from the source cell (first cell # a) and applies the configuration for the target cell.

In step S11, when the cell switching needs to include performing the random access procedure (for example, when the Cell Switch Command does not include a valid TA value), the UE 100 performs the random access procedure on the target cell. Note that, when the TA of the target cell does not need to be acquired upon the cell switching (for example, when the Cell Switch Command includes a valid TA value), the UE 100 can skip the random access procedure.

In step S12, the UE 100 indicates that the cell switching to the target cell is successfully completed. The UE 100 may then perform steps S6 to S12 multiple times for subsequent LTM cell switching based on the configuration provided in step S4.

### (3) C-LTM/RL-CHO

In the cell switching procedure by the LTM as illustrated in FIG. 7, as in the conditional handover, by configuring the execution condition (trigger condition) of the cell switching for the UE 100 in the RRC Reconfiguration message in step S4 in advance, the operations are allowed to be skipped from the L1 Measurement Report in step S7 to the Cell Switch Command (MAC CE) in step S9, thereby the high speed cell switching and the minimized data communication interruption are considered to be possible. Such a procedure of a conditional cell switching by the LTM is also referred to as conditional LTM (C-LTM).

One of the features of the LTM is the early synchronization (Early sync). The early sync allows the random access procedure to be skipped when the cell switching is executed. Such early sync may also be applicable to the conditional handover. A conditional handover that skips a random access procedure when the cell switching (handover) is executed using the early sync is also referred to as RACH-less CHO (RL-CHO). Note that the RL-CHO skips the random access procedure when the cell switching is executed, but performs the random access procedure when the early sync is executed, and does not mean a procedure in which the random access procedure is not performed at all.

Here, in the conventional LTM early sync, the UE 100 triggers the CFRA by receiving the PDCCH order from the source cell before receiving the Cell Switch Command (MAC CE) from the current serving cell (source cell). However, in the C-LTM and/or the RL-CHO (hereinafter referred to as the “C-LTM/RL-CHO”), since the UE 100 autonomously triggers the cell switching, the gNB 200 cannot grasp the timing at which the UE 100 is to perform the early sync. Therefore, there exists a concern that the PDCCH order cannot be used and the CFRA cannot be used also. Although resources for the CFRA can be reserved for the UE 100 in the candidate cell, the gNB 200 cannot recognize when the UE 100 triggers the CFRA, and the CFRA resources may be wasted. In the C-LTM/RL-CHO, since the gNB 200 does not transmit the Cell Switch Command (MAC CE) to the UE 100 as in the conventional LTM, the UE 100 cannot be notified of the TA value by the Cell Switch Command (MAC CE).

In the embodiments, in addition to configuring the cell switching with the trigger condition for the UE 100, configuring the early sync with the trigger condition for the UE 100 allows the UE 100 to autonomously trigger each of the early sync and the cell switching. Here, in the early sync, not the CFRA but the contention free random access (CBRA) is used.

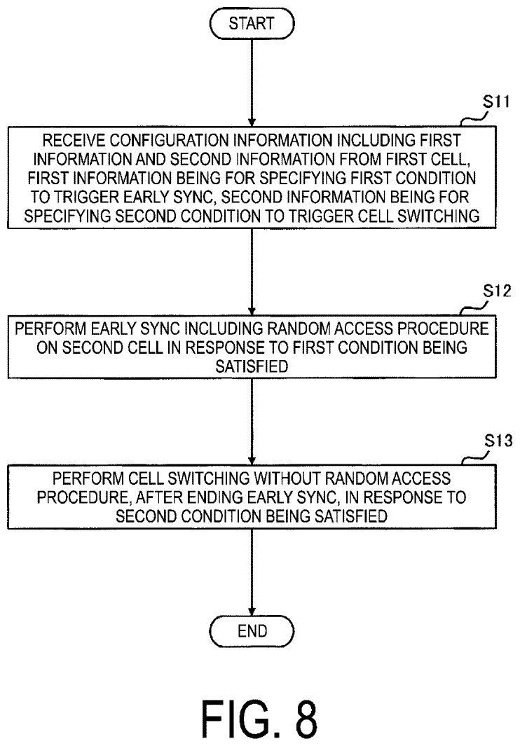

FIG. 8 is a flowchart illustrating an overview of an operation of the UE 100 for the C-LTM/RL-CHO according to the embodiment. The operation of FIG. 8 is an operation for performing the cell switching to change the serving cell of the UE 100 in the RRC connected state from the first cell # a to the second cell # b. Specifically, the operation of FIG. 8 is an operation for implementing the C-LTM/RL-CHO.

In step S11, the UE 100 receives the configuration information including first information and second information from the first cell # a (gNB 200), the first information being for specifying a first condition to trigger the early sync related to the cell switching, the second information being for specifying a second condition to trigger the cell switching. Accordingly, each of the early sync trigger condition and the cell switching trigger condition is configured for the UE 100. Hereinafter, such configuration information may be referred to as “C-LTM/RL-CHO configuration”.

In step S12, the UE 100 performs the early sync including a random access procedure on the second cell # b in response to the first condition configured in step S11 being satisfied. Here, the early sync includes downlink early sync and uplink early sync. The UE 100 performs the random access procedure for the uplink early sync (i.e. TA value acquisition).

In step S13, the UE 100 performs the cell switching without the random access procedure, after ending the early sync, in response to the second condition configured in step S11 being satisfied.

According to such an operation, the UE 100 can autonomously trigger the early sync when the first condition is configured by the gNB 200 and the first is satisfied. Therefore, the UE 100 can trigger the early sync without receiving the PDCCH order from the first cell # a (source cell). Then, the UE 100 performs the cell switching to the second cell # b (target cell) without the random access procedure, after ending the early sync, in response to the configured second condition being satisfied. Accordingly, the C-LTM/RL-CHO can be implemented, and the time from when the second condition is satisfied to when the cell switching is completed can be shortened.

The UE 100 that performs such an operation includes a receiver 110 configured to receive the configuration information including first information and second information from the first cell # a, the first information being for specifying a first condition to trigger the early sync that is related to the cell switching from the first cell # a to the second cell # b, the second information being for specifying a second condition to trigger the cell switching, and a controller 130 configured to perform the early sync including a random access procedure on the second cell # b in response to the first condition being satisfied. The controller 130 performs the cell switching without the random access procedure, after ending the early sync, in response to the second condition being satisfied. On the other hand, the gNB 200 includes a transmitter 210 configured to transmit the configuration information including the first information and the second information to the UE 100 in the first cell # a, the first information being for specifying the first condition to trigger the early sync that is related to the cell switching from the first cell # a to the second cell # b, the second information being for specifying the second condition to trigger the cell switching.

The first information of step S11 may include at least one piece of information of the following 1) to 4).
1) Information indicating a reception quality condition to be satisfied for the first cell # a (serving cell) and/or the second cell # b (candidate cell) in order to trigger the early sync:
The reception quality may be a measurement value of at least one selected from the group consisting of reference signal received power (RSRP), reference signal received quality (RSRQ), signal-to-interference-plus-noise ratio (SINR), received signal strength indicator (RSSI), bit error rate (BER), and block error rate (BLER). The information indicating the reception quality condition may be a threshold to be compared with these measurement values. The information indicating the reception quality condition may include a threshold for the first cell # a (serving cell) and a threshold for the second cell # b (candidate cell). In step S12, the UE 100 performs the early sync in response to the reception quality condition specified in the first information being satisfied (i.e. a reception quality measurement value satisfying a threshold condition).
2) Information indicating a geographical location condition of the UE 100 to be satisfied in order to trigger the early sync:
The geographical location condition may be a geographical location range (i.e., geographical area) in which the UE 100 is to trigger the early sync. The UE 100 measures (that is, positions) its own geographical location using, for example, a global navigation satellite system (GNSS) reception device the UE 100 has, and performs the early sync in response to the location condition specified in the first information being satisfied.
3) Information indicating an artificial intelligence or machine learning (AI/ML) model to be used to infer whether the first condition is satisfied:
Such an AI/ML model may be a trained model for deriving (inferring) and outputting an optimal trigger timing for the early sync using, for example, time series data of reception quality measurement values as an input. The UE 100 may hold such an AI/ML model in advance. In step S12, the UE 100 performs the early sync in response to inferring that the first condition is satisfied by using the AI/ML model.
4) Information indicating reception of the first information or the configuration information of step S11 as the first condition:
In this case, in the step S12, the UE 100 may immediately perform the early sync in response to receiving the first information or the configuration information of the step S11. That is, the UE 100, the UE 100 may perform the early sync because of the C-LTM/RL-CHO configuration being performed. The information 4) may be flag information included in the configuration information of the step S11. The information may be string information indicating the name of the first information or the configuration information of the step S11.

Note that the configuration information of the step S11 may include the TA value for the second cell # b. In step S12, the UE 100 may perform the early synchronization (to be more specific, uplink early sync) only when the TA value for the second cell # b is not included in the configuration information. When the configuration information includes the TA value for the second cell # b, the UE 100 may skip the early sync (to be more specific, the uplink early sync) of the step S12.

The random access procedure in the early sync of step S12 may be a contention based random access (CBRA) procedure. This allows the UE 100 to perform the random access procedure even without receiving the PDCCH order from the first cell # a (serving cell). Information indicating candidates for physical random access channel (PRACH) resources to apply to the CBRA (specifically, candidates for random access preambles and/or candidates for PRACH time/frequency resources) may be included in system information (system information block (SIB)) broadcast from the second cell # b (candidate cell). The information may be included in the configuration information of step S11. The configuration information of the step S11 may explicitly or implicitly specify the CBRA procedure as the random access procedure in the early sync to the UE 100. Note that, unlike the CFRA in which a dedicated random access preamble is allocated to the UE 100, in the CBRA, the UE 100 selects a random access preamble from among random access preamble candidates (a random access preamble group) by itself. Therefore, contention of random access preambles between UEs does not occur in the CFRA, but may occur in the CFRA.

The CBRA procedure in the early sync of step S12 includes transmitting a random access preamble (RA preamble) from the UE 100 to the second cell # b and receiving, by the UE 100, a random access response (RAR) from the second cell # b.

In step S12, the UE 100 identifies a PRACH resource dedicated to the random access preamble transmission for the early sync. For example, some of candidates for the PRACH resource for the CBRA are prepared (designated) as the PRACH resources dedicated to the early sync. The UE 100 performs the random access preamble transmission by using the identified PRACH resource (the random access preamble dedicated to the early sync and/or the PRACH time/frequency resource dedicated to the early sync).

The RAR includes the TA value for the second cell # b. In step S13, the UE 100 checks whether the TA value obtained in the RAR is valid when the second condition is satisfied. When the TA value is valid, the UE 100 performs the cell switching without the random access procedure. On the other hand, when the TA value is invalid when the second condition is satisfied, in step S13, the UE 100 performs the cell switching with the random access procedure.

The configuration information of step S11 may include at least one piece of information of the following 1) to 3).
1) Timer value indicating a valid period of the TA value:
In this case, the UE 100 starts a timer (time alignment timer (TAT)) in which the timer value is set upon receiving the RAR including the TA value. The UE 100 considers the TA value to be valid when the TAT is running and invalid when the TAT expires.
2) Information indicating a geographical range in which the TA value is valid:
In this case, the UE 100 checks whether the geographical location of the UE 100 is within the specified geographical range in order to check whether the TA value is valid. The UE 100 considers the TA value to be valid when the geographical location of the UE 100 is within the specified geographical range. On the other hand, the UE 100 considers the TA value to be invalid when the geographical location of the UE 100 is out of the specified geographical range.
3) Information indicating a reception quality range of the second cell # b in which the TA value is valid:
In this case, the UE 100 checks whether the reception quality of the second cell # b in the UE 100 is within the specified reception quality range in order to check whether the TA value is valid. The UE 100 considers the TA value to be valid when the reception quality of the second cell # b is within the specified reception quality range. On the other hand, the UE 100 considers the TA value to be invalid when the reception quality of the second cell # b is out of the specified reception quality range.

The RAR may include a temporary identifier of the UE 100 in the second cell # b, for example, a cell radio network temporary identifier (C-RNTI). Such C-RNTI is also referred to as a Temporary C-RNTI. In step S13, the UE 100 may transmit an RRC message (e.g., RRC Reconfiguration Complete message) including the Temporary C-RNTI to the second cell # b as an initial transmission to the second cell # b.

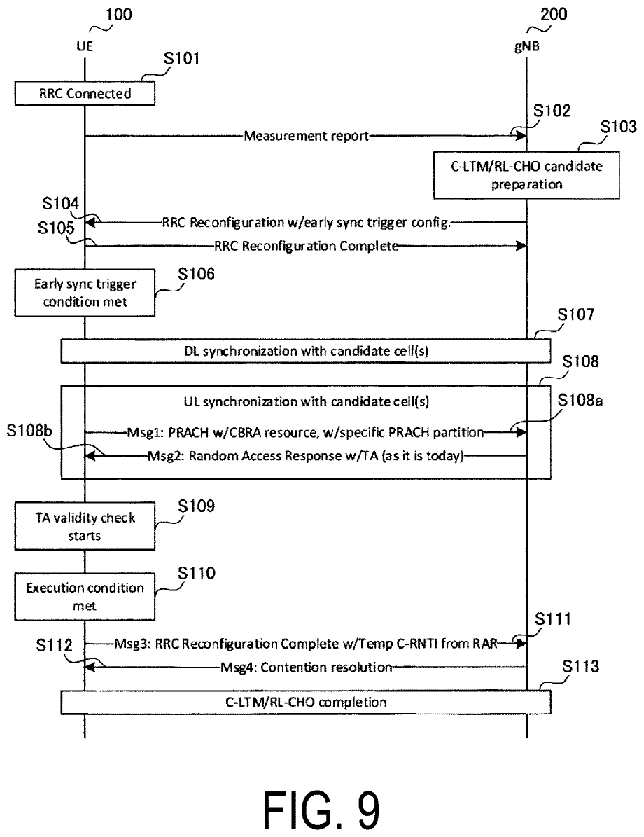

FIG. 9 is a diagram illustrating a specific example of the C-LTM/RL-CHO operation of the mobile communication system 1 according to the embodiment.

In step S101, the UE 100 is in the RRC connected state (RRC Connected) in the first cell # a (serving cell) of the gNB 200. The UE 100 may transmit capability information (UE capability) indicative of supporting the C-LTM/RL-CHO to the gNB 200. The gNB 200 may receive the capability information (UE capability).

In step S102, the UE 100 transmits a Measurement Report message, which is an RRC message, to the gNB 200 (serving cell). The gNB 200 receives the Measurement Report message. The Measurement Report message includes the measurement value of the reception quality of the first cell # a (serving cell) and/or the reception quality of the second cell # b (candidate cell).

In step S103, the gNB 200 determines to configure the C-LTM/RL-CHO for the UE 100 and identifies the candidate cell.

In step S104, the gNB 200 transmits the C-LTM/RL-CHO configuration to the UE 100. The gNB 200a may transmit an RRC message (specifically, RRC Reconfiguration message) including the C-LTM/RL-CHO configuration to the UE 100. The UE 100 receives the C-LTM/RL-CHO configuration from the gNB 200 (serving cell).

The C-LTM/RL-CHO configuration includes a) configuration information related to the conditional early sync and b) other mobility related configuration information. The a) configuration information related to the conditional early sync may include at least one piece of information of the following a1) to a4).
a1) First Condition:
Such configuration information (Early sync trigger config.) explicitly indicates the first condition. The first condition may be a threshold of radio quality such as the RSRP/RSRQ/SINR. The first condition may be a threshold of data reception quality such as the BLER. The first condition may be location information indicating the geographical range defined by latitude, longitude, altitude, and the like. The first condition may be an event (for example, a Measurement event or a Conditional event) defined in the RRC protocol. The first condition may be information indicative of using model inference by the artificial intelligence (AI)/machine learning (ML) model, for example, a model ID or a function ID of the AI/ML model.
a2) Information specifying that a conditional early sync is to be performed:
Such configuration information (Early sync trigger config.) implicitly indicates the first condition. When the C-LTM/RL-CHO configuration includes this information, the UE 100 determines to perform the conditional early sync. In this case, the UE 100 may determine the trigger timing of the early sync with reference to the C-LTM/RL-CHO execution condition (second condition). For example, the UE 100 adds an offset to the reception qualities or thresholds thereof used in the conditional event (for example, adds +3 dB to the RSRP value of the serving cell). The UE 100 triggers the early sync when such a first condition is satisfied. Alternatively, the UE 100 may immediately trigger the early sync upon receiving an RRC Reconfiguration message including the configuration information for the conditional early sync.
a3) Configuration information of the PRACH resource dedicated to the early sync:
By defining the PRACH resource dedicated to the early sync, the gNB 200 may distinguish between a PRACH transmission for the early sync and a PRACH transmission for the initial access, which is not cell switching. The UE 100 selects a PRACH resource to be used for the early sync from among the PRACH resource candidates dedicated to the early sync among the PRACH resource candidates for the CBRA based on the configuration information a3). Such division of the PRACH resources is also referred to as PRACH partitioning. In the PRACH partitioning, some of the PRACH time/frequency resources and/or some of the random access preambles (preamble sequences) are designated (prepared) for a specific use. For example, the UE 100 selects a PRACH resource to be used for the early sync from among the PRACH resource candidates dedicated to the early sync among the random access preamble candidates for the CBRA. By using such a PRACH resource dedicated to the early sync, the gNB 200 that has received the random access preamble from the UE 100 can identify that the RA transmission (access) is caused by the early sync of the C-LTM/RL-CHO, based on the PRACH resource applied to the received random access preamble. Note that the configuration information of the PRACH resource dedicated to the early sync is not limited to the case where the configuration information is signaled for each UE in the C-LTM/RL-CHO configuration, and the first cell # a or the second cell # b may be signaled in common to a plurality of UEs in the SIB.
a4) Configuration information related to the valid period of the TA value:
Since the optimal value of the TA value for the second cell # b, which is a candidate cell, may change depending on the positional relationship (propagation distance) between the UE 100 and the second cell # b, the valid period of the TA value is determined. The configuration information a4) may indicate the valid period of the TA value by any of the following.
Time length:
In this case, the configuration information a4) indicates a time length of the valid period of the TA value acquired by the UE 100. For example, the configuration information may be a timer value set in the timer that measures the valid period of the TA value.
UE movement distance:
In this case, the configuration information a4) indicates an upper limit of a movement distance of the UE 100 in which the TA value is valid after the UE 100 acquires the TA value. The configuration information may be a movement distance threshold. To be more specific, the configuration information may be information of an area range in which the TA value is valid.
UE location:
In this case, the configuration information a4) indicates the geographical location (for example, latitude, longitude, and height) of the UE 100 in which the TA value is valid.
Reception Quality of the Second Cell # b:
In this case, the configuration information a4 may be a reception quality threshold (such as RSRP threshold) of the second cell # b, which is a candidate cell. The UE 100 considers the TA value to be valid when the reception qualities of the second cells # b are within the reception qualities range specified in the configuration information. When there exist a plurality of candidate cells, the configuration information a4) may be separately specified for each candidate cell. That is, the configuration information and the cell ID of the candidate cell may be associated with each other.

On the other hand, other mobility-related configurations b) may include at least one piece of information of at least one selected from the group consisting of pieces of information of the following b1) to b4). Note that the configuration information b) may be configuration information same as and/or similar to the configuration information for general CHO (conditional reconfiguration) that does not use the conditional early sync. When there exist a plurality of candidate cells, b) other mobility-related configurations may be specified separately for each candidate cell.
b1) Candidate cell ID:
This is a cell ID of the candidate cell.
b2) Second condition (CondEvent):
This is information indicating the reception quality condition to be satisfied for the serving cell and/or the candidate cell in order to trigger the cell switching.
b3) RRC configuration:
This is an RRC configuration applied in a candidate cell.
b4) CG (configured grant) configuration:
This is configuration information for configuring an uplink radio resource (for example, a PUSCH resource) available for the initial uplink transmission in the candidate cell.

In step S105, the UE 100 transmits an RRC Reconfiguration Complete message indicative of completing the configuration in the RRC Reconfiguration message in step S104 to the gNB 200 (serving cell). The gNB 200 receives the RRC Reconfiguration Complete message.

In step S106, the UE 100 performs reception quality measurement based on the configuration of step S104 (in particular, the configuration information related to the conditional early sync), evaluates whether the first condition (early sync trigger condition) is satisfied, detects that the condition is satisfied, and triggers the early sync.

In step S107, the UE 100 performs the downlink early sync (DL Synchronization) with the second cell # b. The UE 100 may establish the downlink synchronization with the second cell # b by using synchronization signals (primary synchronization signal and secondary synchronization signal) included in a synchronization signal/PBCH block (SSB) received from the second cell # b, which is a candidate cell.

In step S108, the UE 100 performs the uplink early sync (UL Synchronization) with the second cell # b.

To be more specific, in step S108a, the UE 100 performs the PRACH transmission (random access preamble transmission) by using the PRACH resource dedicated to the early sync among the CBRA resources. The gNB 200 receives the random access preamble from the UE 100. The gNB 200 recognizes that the PRACH transmission is performed in the PRACH resource dedicated to the early sync, and determines that the RACH procedure is for the C-LTM/RL-CHO. The gNB 200 may recognize the transmitting of the RAR of the step S108b, and that the reception of Msg3 (RRC Reconfiguration Complete message) of step S111 is delayed.

In step S108b, the gNB 200 transmits a random access response (RAR) to the UE 100. The UE 100 receives the RAR. The RAR may include at least one selected from the group consisting of a TA value, a Temporary C-RNTI, and a UL grant indicating the uplink radio resource (e.g., a PUSCH resource) used in step S111, as in a normal CBRA procedure.

In step S109, the UE 100 starts a TA value validity check (TA validity check) based on the configuration of the step S104 (in particular, the configuration information related to the conditional early sync). For example, the UE 100 may start the timer (TAT).

In step S110, the UE 100 evaluates whether the cell switching trigger condition (Execution condition) by the C-LTM/RL-CHO is satisfied based on the configuration of step S104 (particularly, other mobility-related configurations), and detects that the condition is satisfied. For example, the UE 100 detects that a CondEvent A3 is satisfied.

In step S111, when the TA value is valid, the UE 100 transmits the RRC Reconfiguration Complete message (Msg3) to the second cell # b (target cell). The UE 100 may determine that the TA value is valid when the timer (TAT) is running. The gNB 200 receives the RRC Reconfiguration Complete message.

Here, the UE 100 may transmit the RRC Reconfiguration Complete (Msg3) by using an uplink resource (PUSCH transmission) allocated by either a configured grant (CG) or a UL grant. For example, when the CG configuration is performed in step S104, the UE 100 performs the PUSCH transmission using the CG resource. When the CG configuration is not performed in the step S104, the UE 100 may monitor the PDCCH of the second cell # b (target cell), and when receiving a PDCCH scrambled by the Temporary C-RNTI (UL grant, also referred to as “Dynamic grant”), perform the PUSCH transmission in accordance with the UL grant. When the UE 100 receives the UL grant in step S108b, the UE may perform the PUSCH transmission in accordance with the UL grant.

On the other hand, when the TA value is not valid, the UE 100 performs the RACH procedure (CBRA) again on the second cell # b, and transmits the RRC Reconfiguration Complete message to the second cell # b. For example, when the timer (TAT) has expired, the UE 100 determines that the TA value is invalid. Alternatively, when the TA value is not valid, the UE 100 may perform the early sync again. Whether to perform the early sync upon the TA expiration may be configured from the gNB 200 for the UE 100.

Note that in step S108, the UE 100 may perform the CFRA through the PDCCH order, as in step S6 of FIG. 6. When the timer (TAT) expires (i.e., before step S111), the UE 100 may discard the currently acquired TA value, or may perform the UL synchronization processing (CBRA) of step S108 again. The UE 100 may stop (or discard) the timer (TAT) when the cell switching is completed in step S113.

In step S112, the gNB 200 transmits Msg4 to the UE 100. The UE 100 receives Msg4 from the gNB 200 (target cell). The UE 100 may determine that the C-LTM/RL-CHO is completed at the time of receiving the PDCCH (DCI including a cyclic redundancy code (CRC) scrambled by the Temporary C-RNTI) from the target cell (step S113). The DL transmission from the gNB 200 may be accompanied by a PDSCH (Contention Resolution MAC CE).

When a contention occurs and a contention resolution is failed, the UE 100 may perform the RACH procedure (CBRA) again. The UE 100 may consider such a failure to be a handover failure (HOF). The UE 100 may start access to another candidate cell (CBRA).

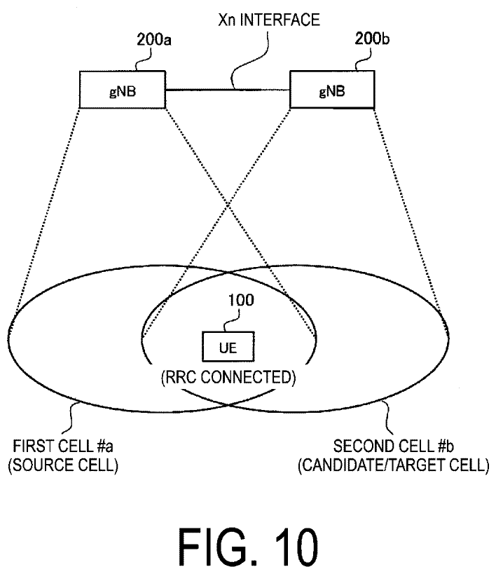

In the operation scenario described above, the cell switching between the cells (C-LTM/RL-CHO) in the same gNB (in the same CU), that is, intra-gNB C-LTM/RL-CHO, is assumed. However, as illustrated in FIG. 10, the operation according to the above-described embodiment may be applied to the cell switching between the cells (C-LTM/RL-CHO) of different gNBs (different CUs), that is, inter-gNB C-LTM/RL-CHO. In the illustrated example, a gNB 200a manages the first cell # a and a gNB 200b may manage the second cell # a. In this case, between step S103 and step S104 in FIG. 9, the gNB 200a may transmit to the gNB 200b a request message of the C-LTM/RL-CHO on the Xn interface, and the gNB 200b may transmit to the gNB 200a a response message of the C-LTM/RL-CHO on the Xn interface.

Here, the request message may be a Handover Request message including information indicative of being the C-LTM/RL-CHO or desiring the C-LTM/RL-CHO. The message may be a request message dedicated to the C-LTM/RL-CHO. The Handover Request message is a request message used for a general handover and a conditional handover.

The response message may be a Handover Request Acknowledge message. The response message may be a response message dedicated to the C-LTM/RL-CHO. The Handover Request Acknowledge message is a response message used for a general handover and a conditional handover. The response message may include information indicative of admitting a HO as a C-LTM/RL-CHO and/or a configuration (trigger condition, etc.) related to the early sync.

### (4) Improvement of C-LTM/RL-CHO

In the case of the general LTM, since a Cell Switch Command MAC CE is explicitly transmitted from the first cell # a (gNB 200) to the UE 100, the first cell # a (gNB 200) knows when the UE 100 performs the cell switching. However, in the case of the C-LTM/RL-CHO, since the cell switching is performed at a UE origin, the first cell # a (gNB 200) does not know when the UE 100 performs the cell switching.

Therefore, there exists a problem in that the first cell # a (gNB 200) does not know when to stop the DL transmission to the UE 100. Since the UE 100 cannot receive the DL packet transmitted by the first cell # a (gNB 200) after the UE 100 executes the cell switching, the radio resources are wasted.

In the case of the inter-gNB C-LTM/RL-CHO, the source gNB (gNB 200a) does not know when to execute data forwarding of the DL data addressed to the UE. For example, in a case that the UE 100 transfers the DL data from the source gNB (gNB 200a) to the target gNB (gNB 200b) before executing the cell switching, back-haul communication resources may be wasted.

The following embodiment describes an operation for efficiently implementing the C-LTM/RL-CHO in which the first cell # a (gNB 200a) can grasp the timing at which the UE 100 performs the UL early sync and/or the cell switching in the C-LTM/RL-CHO.

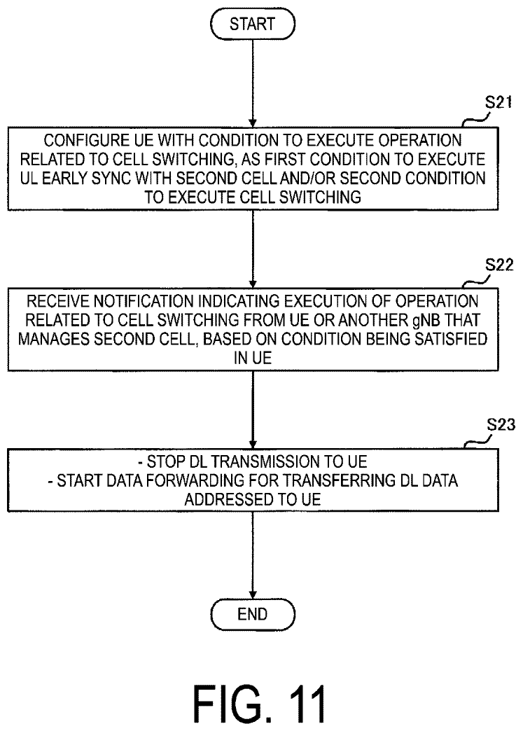

FIG. 11 is a flowchart illustrating an operation of the gNB 200 for improvement of the C-LTM/RL-CHO according to the embodiment. In a case of the intra gNB C-LTM/RL-CHO, the gNB 200 that performs the operation is the gNB 200 that manages the first cell # a and the second cell # b (see FIG. 6). On the other hand, in a case of the inter-gNB C-LTM/RL-CHO, the gNB 200 that performs the operation is the gNB 200a that manages the first cell # a (see FIG. 10).

In step S21, the gNB 200 (gNB 200a) that manages the first cell # a configures the UE 100 with a condition to execute an operation related to the cell switching, as the first condition to execute UL early sync with the second cell # b and/or the second condition to execute the cell switching.

In step S22, the gNB 200 (gNB 200a) that manages the first cell # a receives a notification indicating execution of the operation related to the cell switching from the UE 100 or the gNB 200b that manages the second cell # b, based on the condition being satisfied in the UE 100. For example, the notification may be a notification indicating the execution of the UL early sync.

In step S23, the gNB 200 (gNB 200a) that manages the first cell # a stops the DL transmission to the UE 100 in response to receiving of the notification of step S22. The gNB 200 (gNB 200a) that manages the first cell # a may start the data forwarding for transferring the DL data addressed to the UE 100 to the gNB 200b, in response to receiving the notice.

According to such an operation, the C-LTM/RL-CHO can be efficiently performed. Note that although such an operation is applicable to both the intra-gNB C-LTM/RL-CHO and the inter-gNB C-LTM/RL-CHO, in the case of the intra-gNB C-LTM/RL-CHO, the data forwarding is not needed.

The gNB 200 (gNB 200a) that performs such an operation includes the controller 230 that configures the UE 100t with a condition to execute an operation related to the cell switching, as the first condition to execute UL early sync and/or the second condition to execute the cell switching, and the receiver 220 or 242 that receives a notification indicating execution of the operation from the UE 100 or the gNB 200b that manages the second cell # b, based on the condition being satisfied in the UE 100.

In a first operation pattern according to the embodiment, the gNB 200 (gNB 200a) receives the notification of step S22 from the UE 100. The gNB 200 (gNB 200a) may receive the notification indicating the execution of the UL early sync from the UE 100, based on the first condition being satisfied in the UE 100. The gNB 200 (gNB 200a) may receive the notification indicating the execution of the cell switching from the UE 100, based on the second condition being satisfied in the UE 100.

In a second operation pattern according to the embodiment, the inter-gNB C-LTM/RL-CHO is assumed, and the gNB 200a receives the notification of step S22 from the gNB 200b. To be more specific, the gNB 200a receives the notification indicating the execution of the UL early sync from the gNB 200b, based on the first condition being satisfied in the UE 100.

### (4.1) Example of First Operation Pattern

The UE 100 according to the first operation pattern includes the receiver 110 that receives, from the gNB 200 that manages the first cell # a, information configuring a condition to execute an operation related to the cell switching, as the first condition to execute UL early sync with the second cell # b and/or the second condition to execute the cell switching, and a transmitter 120 that transmits a notification indicating execution of the operation to the gNB 200a, based on the condition being satisfied.

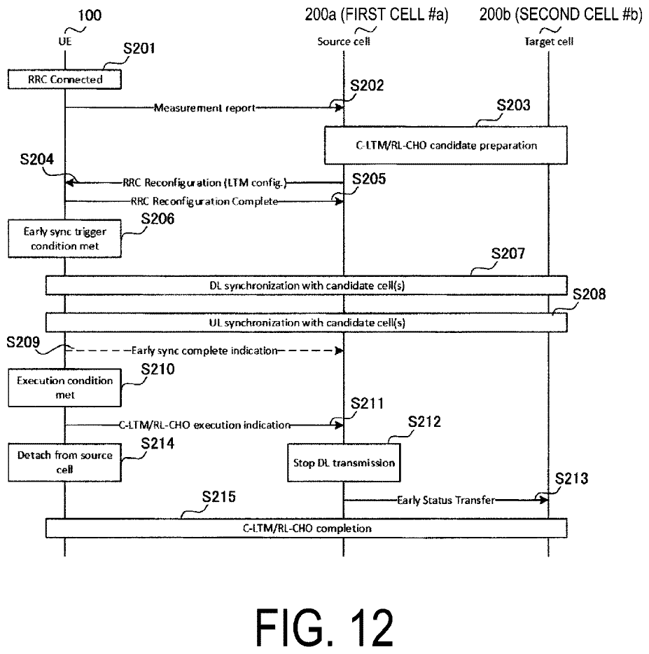

FIG. 12 is a diagram illustrating an example of the first operation pattern according to the embodiment. In the illustrated example, the inter-gNB C-LTM/RL-CHO scenario is assumed. However, the first operation pattern according to the embodiment may be applied to the intra gNB C-LTM/RL-CHO scenario. In the following description of the embodiment, the operation described with reference to FIGS. 7 and 9 may be applied as appropriate, although redundant description of the operation described with reference to FIGS. 7 and 9 will be omitted.

In step S201, the UE 100 is in the RRC connected state, where the serving cell thereof is the first cell # a (gNB 200a).

In step S202, the UE 100 may transmit a measurement report message to the first cell # a (gNB 200a). The first cell # a (gNB 200a) may receive the measurement report message.

In step S203, the first cell # a (gNB 200a) prepares the inter-gNB C-LTM/RL-CHO with the second cell # b (gNB 200b).

In step S204, the first cell # a (gNB 200a) transmits an RRC Reconfiguration message including the LTM configuration to the UE 100. The LTM configuration includes the first information that is a configuration of the first condition (early sync trigger condition) and the second information that is a configuration of the second condition (execution condition). The UE 100 receives the RRC Reconfiguration message including the LTM configuration.

In step S205, the UE 100 transmits an RRC Reconfiguration Complete message to the first cell # a (gNB 200a). The first cell # a (gNB 200a) receives the RRC Reconfiguration Complete message.

In step S206, the UE 100 confirms that the configured first condition (early sync trigger condition) is satisfied.

In step S207, the UE 100 performs processing of DL early sync with the second cell # b (gNB 200b) in response to the first condition (early sync trigger condition) being satisfied.

In step S208, the UE 100 performs processing of UL early sync with the second cell # b (gNB 200b) in response to the first condition (early sync trigger condition) being satisfied. Here, the UE 100 may acquire the TA value of the second cell # b (gNB 200b) on a random-access (RA) basis. The UE 100 may acquire the TA value of the second cell # b (gNB 200b) through UE-based measurement.

In step S209, the UE 100 notifies the first cell # a (gNB 200a) that the early sync processing is completed, in accordance with the completion (success) of the early sync processing. The UE 100, the UE100 may transmit the notification to the first cell # a (gNB 200) in a MAC CE, an RRC message (e.g., a UE assistance information message), or uplink control information (UCI). The notification may include an identifier (cell ID or the like) of the corresponding second cell # b (gNB 200b). The notification may include information indicating that the early sync trigger condition of the C-LTM/RL-CHO is satisfied. The first cell # a (gNB 200a) receives the notification.

Note that the UE 100 may transmit the notification when the first condition is satisfied. That is, the UE 100 may transmit the notification before performing the early sync processing. In this case, the notification may be a notification that the early sync processing is to be executed thereafter.

In step S210, the UE 100 confirms that the configured second condition (execution condition) is satisfied.

In step S211, in response to the second condition (execution condition) being satisfied, the UE 100 notifies the first cell # a (gNB 200a) of the execution of the cell switching by the C-LTM/RL-CHO. The UE 100 may transmit the notification to the first cell # a (gNB 200) in a MAC CE, an RRC message (e.g., a UE assistance information message), or uplink control information (UCI). The notification may include an identifier (cell ID or the like) of the corresponding second cell # b (gNB 200b). The notification may include information indicating that the cell switching trigger condition of the C-LTM/RL-CHO is satisfied. That is, the UE 100 transmits the notification indicating that the second condition (execution condition) of the C-LTM/RL-CHO different from the trigger condition of the existing CHO is satisfied. The information may be a configuration index (LTM configuration index) included in the LTM configuration of step S204. The first cell # a (gNB 200a) receives the notification.

Note that the UE 100 may transmit both the notification of step S209 and the notification of step S211. The UE 100 may transmit only one of the notification of step S209 and the notification of step S211. The first cell # a (gNB 200) may configure which notification is to be transmitted in the UE 100 in step S204.

In step S212, the first cell # a (gNB 200a) stops the DL transmission to the UE 100 in response to receiving of the notification of either step S209 or step S211. For example, the first cell # a (gNB 200a) may stop the allocation of the DL radio resource to the UE 100.

In step S213, the first cell # a (gNB 200a) starts data forwarding for transferring the DL data addressed to the UE 100 to the second cell # b (gNB 200b) in response to receiving of the notification of either step S209 or step S211. For example, the first cell # a (gNB 200a) may transmit Early Status Transfer for starting the data forwarding to the second cell # b (gNB 200b).

Note that the first cell # a (gNB 200a) may perform the processing of steps S212 and S213 after a certain period of time elapses from when receiving the notification of either step S209 or step S211.

In step S214, the UE 100 performs the cell switching. To be more specific, the UE 100 detaches from the first cell # a (gNB 200a) and transmits the RRC Reconfiguration Complete message to the second cell # b (gNB 200b) in step S215. Note that the UE 100 may transmit the notification of step S211 immediately before detaching from the first cell # a (gNB 200a).

### (4.2) Example of Second Operation Pattern

The second operation pattern is described mainly with respect to differences from the first operation pattern.

The gNB 200b according to the second operation pattern includes the receiver 220 that receives, from the UE 100 configured with a condition to execute UL early sync with the second cell # b, a random access signal (RA preamble) for the UL early sync in response to the condition being satisfied in the UE 100, and the transmitter 241 that transmits a notification indicating execution of the UL early sync to the gNB 200a based on receiving of the random access signal. That is, the second cell # b (gNB 200b) having performed the UL early sync (early UL synchronization) with UE 100 notifies the first cell # a (gNB 200a) that the UL synchronization with the UE 100 has been performed.

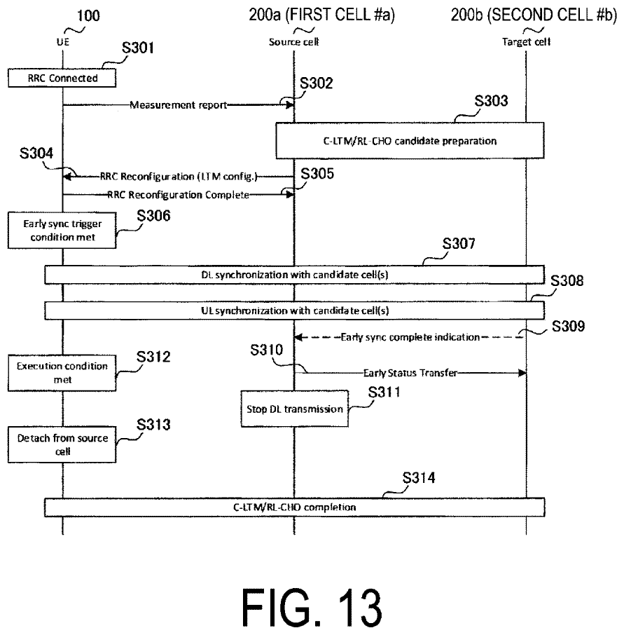

FIG. 13 is a diagram illustrating an example of the second operation pattern according to the embodiment.

Steps S301 to S308 are similar to and/or the same as steps S201 to S208 of the first operation pattern (FIG. 12).

In step S309, the second cell # b (gNB 200b) notifies the first cell # a (gNB 200a) that the UL early sync processing (UL early sync) is completed, in accordance with the completion (success) of the UL early sync processing. The second cell # b (gNB 200b) may transmit the notification to the first cell # a (gNB 200a) by using an Xn Handover Request Ack message or a gNB configuration update message indicating a gNB configuration update.

The notification in step S309 may include an identifier of the UE 100 on the Xn interface (such as an Xn-AP-UE-ID).

The notification of step S309 may include the cell ID of the cell of which the TA value the UE 100 has acquired (which may be a target cell ID, or a list of target cell IDs to which the TA can be applied). The cell ID may be used by the first cell # a (gNB 200a) to identify the cell switching trigger condition of the C-LTM/RL-CHO and to estimate the timing of executing the cell switching in the UE 100.

The notification of step S309 may include information of UL received power (for example, PRACH received power, SRS received power, etc.) from the UE 100. The received power value may be used by the first cell # a (gNB 200a) to grasp a link state (for example, path loss) between the UE 100 and the second cell # b (gNB 200b) and to estimate the timing of executing the cell switching in the UE 100. In the C-LTM/RL-CHO, since the first cell # a (gNB 200a) cannot acquire the L1 measurement report as illustrated in FIG. 7, the received power value can be used to estimate the link state between the UE 100 and the second cell # b (gNB 200b). Note that power ramping, which increases the UL transmission power each time the RA preamble is transmitted, may be applied to the PRACH, but in the UL early sync of the C-LTM/RL-CHO, there may be a restriction that the transmission power of the PRACH is fixed (not ramped).

The notification of step S309 may be a request to start an early status transfer (data forwarding). That is, the second cell # b (gNB 200b) requests the data forwarding from the first cell # a (gNB 200a) (that is, notifies the first cell # a (gNB 200a) that preparation for receiving the data forwarding is completed) in accordance with the completion of the early sync processing of the UE 100.

In step S310, the first cell # a (gNB 200a) starts data forwarding for transferring the DL data addressed to the UE 100 to the second cell # b (gNB 200b) in response to receiving of the notification of step S309. For example, the first cell # a (gNB 200a) may transmit Early Status Transfer for starting the data forwarding to the second cell # b (gNB 200b).

In step S311, the first cell # a (gNB 200a) stops the DL transmission to the UE 100 in response to receiving of the notification of step S309. For example, the first cell # a (gNB 200a) may stop the allocation of the DL radio resource to the UE 100.

Note that the first cell # a (gNB 200a) may perform the processing of steps S310 and S311 after a certain period of time elapses from when receiving the notification of step S309.

In step S312, the UE 100 confirms that the configured second condition (execution condition) is satisfied.

In step S313, the UE 100 executes the cell switching in response to the second condition (execution condition) being satisfied. To be more specific, the UE 100 detaches from the first cell # a (gNB 200a) and transmits the RRC Reconfiguration Complete message to the second cell # b (gNB 200b) in step S314.

### (5) Other Embodiments

The above-described embodiment describes the example of signaling on the Xn interface by the inter-node communication between the first cell # a (gNB 200a) and the second cell # b (gNB 200b). However, it may be also applied to signaling performed on an F1 interface between the DU and the CU.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed. The order of the steps may be changed in each flow.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM and/or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure.

### (6) Supplementary Notes

Features relating to the embodiments described above are described below as supplementary notes.

### Supplementary Note 1

A communication method for performing cell switching to switch a serving cell of a user equipment from a first cell to a second cell, the communication method including:
configuring, by a first network node configured to manage a first cell, a user equipment with, as a condition to execute an operation related to the cell switching, a first condition to execute uplink early synchronization with the second cell and/or a second condition to execute the cell switching; and
receiving, by the first network node, a notification indicating the execution of the operation from the user equipment or a second network node configured to manage the second cell, based on the condition being satisfied at the user equipment.

### Supplementary Note 2

The communication method according to supplementary note 1, further including: stopping, by the first network node, downlink transmission to the user equipment in response to the receiving of the notification.

### Supplementary Note 3

The communication method according to supplementary note 1 or 2, further including: starting, by the first network node, data forwarding for transferring downlink data addressed to the user equipment to the second network node in response to the receiving of the notification.

### Supplementary Note 4

The communication method according to any one of supplementary notes 1 to 3, wherein the first network node receives the notification indicating the execution of the uplink early synchronization from the user equipment, based on the first condition being satisfied at the user equipment.

### Supplementary Note 5

The communication method according to any one of supplementary notes 1 to 3, wherein the first network node receives the notification indicating the execution of the cell switching from the user equipment, based on the second condition being satisfied at the user equipment.

### Supplementary Note 6

The communication method according to any one of supplementary notes 1 to 3, wherein the first network node receives the notification indicating the execution of the uplink early synchronization from the second network node, based on the first condition being satisfied at the user equipment.

### Supplementary Note 7

A network node for managing a first cell in a mobile communication system for performing cell switching to switch a serving cell of a user equipment from the first cell to a second cell, the network node including:
a controller configured to configure a user equipment with, as a condition to execute an operation related to the cell switching, a first condition to execute uplink early synchronization with the second cell and/or a second condition to execute the cell switching; and
a receiver configured to receive a notification indicating the execution of the operation from the user equipment or a second network node configured to manage the second cell, based on the condition being satisfied at the user equipment.

### Supplementary Note 8

A user equipment in a mobile communication system for performing cell switching to switch a serving cell of the user equipment from a first cell to a second cell, the user equipment including: a receiver configured to receive, from a first network node configured to manage the first cell, information for configuring, as a condition to execute an operation related to the cell switching, a first condition to execute uplink early synchronization with a second cell and/or a second condition to execute the cell switching; and
a transmitter configured to transmit a notification indicating the execution of the operation to the first network node, based on the condition being satisfied.

### Supplementary Note 9

A network node for managing a second cell in a mobile communication system for performing cell switching to switch a serving cell of a user equipment from a first cell to the second cell, the network node including:
a receiver configured to receive, from a user equipment configured with a condition to execute uplink early synchronization with the second cell, a random access signal for uplink early synchronization in response to the condition being satisfied at the user equipment; and
a transmitter configured to transmit a notification indicating the execution of the uplink early synchronization to a first network node, based on the receiving of the random access signal.

### REFERENCE SIGNS

1: Mobile communication system
5: Network
10: CN
20: RAN
100: UE
110: Receiver
120: Transmitter
130: Controller
140: Wireless communicator
200: gNB
210: Transmitter
220: Receiver
230: Controller
240: Network communicator
241: Transmitter
242: Receiver
250: Wireless communicator
300: AMF/UPF

1. A communication method for performing cell switching to switch a serving cell of a user equipment from a first cell to a second cell, the communication method comprising:
configuring, by a first network node configured to manage a first cell, a user equipment with, as a condition to execute an operation related to the cell switching, a first condition to execute uplink early synchronization with the second cell and/or a second condition to execute the cell switching; and
receiving, by the first network node, a notification indicating the execution of the operation from the user equipment or a second network node configured to manage the second cell, based on the condition being satisfied at the user equipment.

2. The communication method according to claim 1, further comprising:
stopping, by the first network node, downlink transmission to the user equipment in response to the receiving of the notification.

3. The communication method according to claim 1, further comprising:
starting, by the first network node, data forwarding for transferring downlink data addressed to the user equipment to the second network node in response to the receiving of the notification.

4. The communication method according to claim 1, wherein
the first network node receives the notification indicating the execution of the uplink early synchronization from the user equipment, based on the first condition being satisfied at the user equipment.

5. The communication method according to claim 1, wherein
the first network node receives the notification indicating the execution of the cell switching from the user equipment, based on the second condition being satisfied at the user equipment.

6. The communication method according to claim 1, wherein
the first network node receives the notification indicating the execution of the uplink early synchronization from the second network node, based on the first condition being satisfied at the user equipment.

7. A network node for managing a first cell in a mobile communication system for performing cell switching to switch a serving cell of a user equipment from the first cell to a second cell, the network node comprising:
a controller configured to configure a user equipment with, as a condition to execute an operation related to the cell switching, a first condition to execute uplink early synchronization with the second cell and/or a second condition to execute the cell switching; and
a receiver configured to receive a notification indicating the execution of the operation from the user equipment or a second network node configured to manage the second cell, based on the condition being satisfied at the user equipment.

8. A user equipment in a mobile communication system for performing cell switching to switch a serving cell of the user equipment from a first cell to a second cell, the user equipment comprising:
a receiver configured to receive, from a first network node configured to manage the first cell, information for configuring, as a condition to execute an operation related to the cell switching, a first condition to execute uplink early synchronization with a second cell and/or a second condition to execute the cell switching; and
a transmitter configured to transmit a notification indicating the execution of the operation to the first network node, based on the condition being satisfied.
